(19) United States
(12) Patent Application Publication
(10) Pub. No.: US 2025/0220402 A1
(43) Pub. Date: Jul. 3, 2025

(54) O-RAN COMPLIANT PROGRAMMABLE RAN PLATFORM

(71) Applicant: Microsoft Technology Licensing, LLC, Redmond, WA (US)

(72) Inventors: Xenofon FOUKAS, Cambridge (GB); Bozidar RADUNOVIC, Cambridge (GB); Connor SETTLE, Cambridge (GB); Matthew BALKWILL, Trowbridge (GB)

(21) Appl. No.: 18/400,564

(22) Filed: Dec. 29, 2023

(51) Int. Cl. H04W 4/60; H04W 4/50

(52) U.S. Cl. CPC H04W 4/60; H04W 4/50

(57) ABSTRACT

A communications network utilizes dynamic service models to facilitate programmability within a radio access network. An analysis node is configured to execute an analysis application based on information from a virtual network function. The virtual network function configured to provide a dynamic service model that defines one or more hook points within instructions for operating the virtual network function and one or more parameters that can be accessed by a codelet at the hook point. The virtual network function dynamically receives a codelet from the analysis node. The virtual network function verifies that the codelet complies with the dynamic service model. The virtual network function executes the codelet at one of the hook points.

### TECHNICAL FIELD

The present disclosure relates to communications networks and, in particular, a programmable radio access network (RAN) platform that is compliant with open-RAN.

### BACKGROUND

A radio access network (RAN) may provide multiple user devices with wireless access to a network. The user devices may wirelessly communicate with a base station, which forwards the communications towards a core network. Conventionally, a base station in the RAN is implemented by dedicated processing hardware (e.g., an embedded system) located close to a radio unit including antennas. The base station may perform lower layer processing including physical (PHY) layer and media access control (MAC) layer processing for one or more cells. There may be costs associated with deploying dedicated processing hardware for each base station in a RAN, particularly for a RAN including small cells with relatively small coverage areas. Additionally, the dedicated processing hardware may be a single point of failure for the cell.

A virtualized radio access network may utilize an edge data center with generic computing resources for performing RAN processing for one or more cells. That is, instead of performing PHY and MAC layer processing locally on dedicated hardware, a virtualized radio access network may forward radio signals from the radio units to the edge data center for processing and similarly forward signals from the edge data center to the radio units for wireless transmission. In one specific example, cloud-computing environments can be used to provide mobile edge computing (MEC) where certain functions of a mobile network can be provided as workloads on nodes in the cloud-computing environment. In MEC, a centralized unit (CU) can be implemented in a back-end node, one or more distributed units (DUs) can be implemented in intermediate nodes, and various remote units (RU), which can provide at least PHY and/or MAC layers of a base station or other RAN node of the mobile network, can be deployed at edge servers. The RUs can communicate with the CU via one or more DUs. In an example, the DUs can provide higher network layer functionality for the RAN, such as radio link control (RLC) or packet data convergence protocol (PDCP) layer functions. The RUs can facilitate access to the CU for various downstream devices, such as user equipment (UE), Internet-of-Things (IoT) devices, etc.

Because the edge data center utilizes generic computing resources, a virtualized RAN may provide scalability and fault tolerance for base station processing. For example, the edge data center may assign a variable number of computing resources (e.g., servers) to perform PHY layer processing for the radio units associated with the edge data center based on a workload. Further, a virtualized RAN may implement multiple layers of RAN processing at a data center, enabling collection of multiple data feeds.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects, the techniques described herein relate to a computing system including: a memory storing computer-executable instructions for operating a network function; and one or more processors configured to execute the instructions for operating the network function, wherein the one or more processors are configured to: provide a dynamic service model that defines one or more hook points within the instructions for operating a network function and one or more parameters that can be accessed by a codelet at the hook point; dynamically receive a codelet from an analysis node; verify that the codelet complies with the dynamic service model; and execute the codelet at one of the hook points.

In some aspects, the techniques described herein relate to a method including: providing, by a network function, a dynamic service model that defines one or more hook points within instructions for operating the network function and one or more parameters that can be accessed by a codelet at the hook point; dynamically receiving a codelet from an analysis node; verifying that the codelet complies with the dynamic service model; and executing the codelet at one of the hook points.

In some aspects, the techniques described herein relate to a communications network including: an analysis node configured to execute an analysis application based on information from a virtual network function; and the virtual network function configured to: provide a dynamic service model that defines one or more hook points within instructions for operating the virtual network function and one or more parameters that can be accessed by a codelet at the hook point; dynamically receive a codelet from the analysis node; verify that the codelet complies with the dynamic service model; and execute the codelet at one of the hook points.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram of an example virtualized radio access network (vRAN) connecting a user equipment (UE) to a core network.

FIG. 2 is a diagram of a first example network architecture for dynamic service models.

FIG. 3 is a diagram of a second example network architecture for dynamic service models.

FIG. 4 is a diagram of a third example network architecture for dynamic service models.

FIG. 5 is a flow diagram of an example of a method for using a dynamic service model to provide access to operational data of a radio access network virtual function to an analysis node within an O-RAN framework.

FIG. 6 is a message diagram of example communications for executing a codelet to export operational data.

FIG. 7 illustrates an example of a computing device including additional optional component details.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to a programmable RAN platform that supports added features of network functions using dynamic service models.

A key transformation of the Radio Access Network (RAN) in 5G is the migration to an Open RAN architecture, that sees the 5G RAN virtualized and disaggregated across multiple open interfaces. This approach fosters innovation by allowing multiple vendors to come up with unique solutions for different components at a faster pace. Furthermore, a new component introduced in the Open RAN architecture called a Radio Intelligent Controller (RIC) allows third parties to build new, vendor-agnostic monitoring and optimization use cases over interfaces standardized by O-RAN.

Despite this compelling vision, the opportunity for innovation still largely remains untapped because of two main challenges. The first challenge is related to the flexible data collection for monitoring and telemetry applications. The RAN functions can generate huge volumes of telemetry data at a high frequency (e.g., gigabytes per second). Collecting, transferring, and processing this data can put a strain on compute and network capacity. A conventional approach, standardized by the 3rd generation partnership project (3GPP), defines a small set of aggregate cell key performance indicators (KPIs) collected every few seconds or minutes. The O-RAN RIC extends this idea by providing new KPIs at a finer time granularity. The O-RAN RIC may be classified as a near real-time RIC. Each KPI is defined through a service model (a form of API), most of them standardized by O-RAN. However, this approach is slow to evolve and does not scale well because of a limited number of initial use cases and a need to standardize new proposals. The second challenge is due to the real-time nature of many RAN control and data plane operations. Any new functionality added to these operations, in order to support a new service model, must be completed within a deadline, typically ranging from microseconds (μs) to a few milliseconds (ms). A deadline violation may cause performance degradation or even crash a vRAN. Any changes on these critical paths can create substantial design challenges and make RAN vendors reluctant to add new features.

In an aspect, the dynamic service models of the present application extend the concept of a service model in the O-RAN architecture to increase flexibility for data access. A conventional service model in O-RAN defines communications for a RAN function over an interface. In contrast, a dynamic service model defines one or more hook points within the instructions for operating a network function and one or more parameters that can be accessed by a codelet at the hook point. The codelet may then communicate with other O-RAN nodes via an existing O-RAN interface (e.g., the E2 interface) or a new interface described herein (e.g., an O3 interface). The use of a dynamic service model allows standardization within the concept of a service model while also allowing flexibility to meet specific needs of RAN applications.

In an aspect, the present disclosure describes a computing system for providing an O-RAN compliant programmable RAN platform using dynamic service models for codelets to execute within a network function. A computing system (e.g., at a far-edge datacenter) includes a memory storing computer-executable instructions for operating a network function and one or more processors configured to execute the instructions for operating the network function. The one or more processors are configured to provide a dynamic service model that defines one or more hook points within the instructions for operating a network function and one or more parameters that can be accessed by a codelet at the hook point. The computing system is configured to dynamically receive a codelet from an analysis node (e.g., a RIC or SMO). The computing system can verify that the codelet complies with the dynamic service model. That is, the codelet is compliant with a standard and also compliant with safety rules (e.g., run time limits). The one or more processors may execute the codelet at one of the hook points. For example, the codelet may export parameters to the analysis node or make a decision based on the parameters (e.g., by applying the parameters to an ML model).

In an example, the computing system may be an edge server or an edge server rack including multiple edge servers. The RAN virtual functions are protected by isolation from the analysis node via a specified O-RAN interface using the dynamic service model. The processor core(s) executing the RAN virtual functions are configured with a codelet that outputs operational data specified in the dynamic service model over the O-RAN interface. The codelet is further configured to receive control information over the interface. The analysis node may include one or more dynamically loaded programs that execute in parallel with the RAN virtual functions. The dynamically loaded programs are configured to receive operational data via the interface, perform processing on the operational data, and send commands for the RAN virtual functions via the interface.

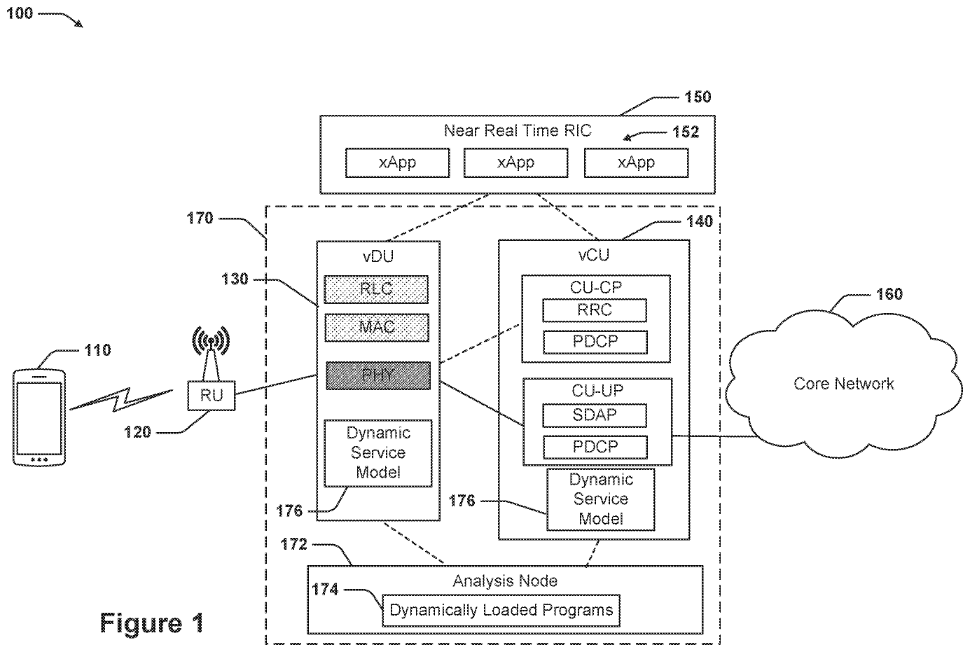

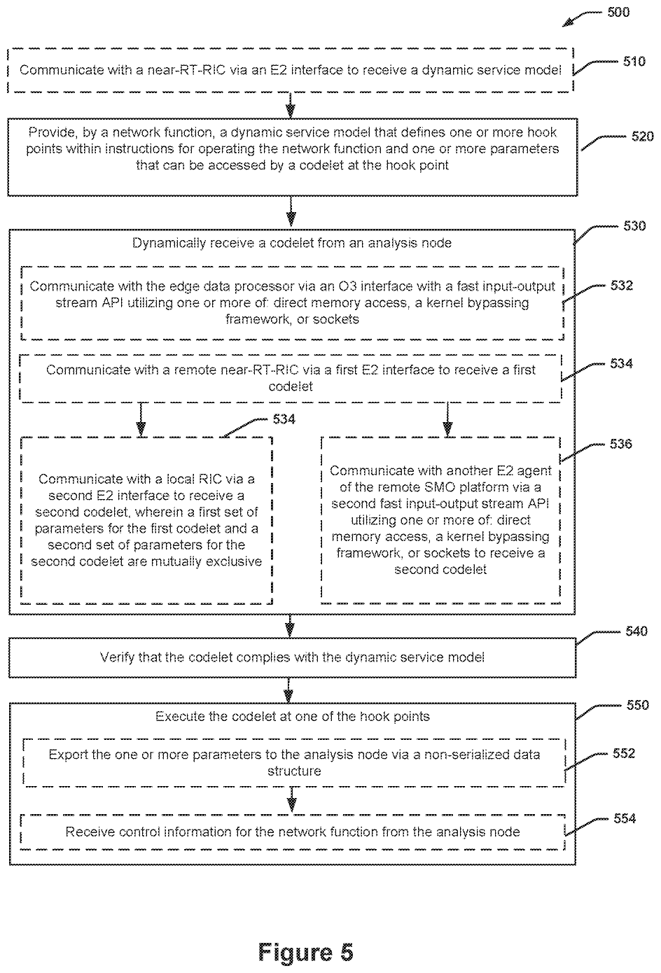

Turning now to FIGS. 1-7, examples are depicted with reference to one or more components and one or more methods that may perform the actions or operations described herein, where components and/or actions/operations in dashed line may be optional. Although the operations described below in FIG. 5 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and a software component capable of performing the described actions or functions.

FIG. 1 is a diagram of an example vRAN 100 connecting a user equipment (UE) 110 to a core network 160. The vRAN 100 may include radio units 120 that transmit and receive wireless signals with the UE 110. The vRAN 100 may include a virtual distributed unit (vDU) 130 that performs processing, for example, at the physical (PHY) layer, media access control (MAC) layer, and radio link control (RLC) layer. The vRAN 100 may include a virtual central unit (vCU) 140 that performs processing at higher layers of the wireless protocol stack. The vRAN 100 may include a near real-time RAN intelligent control (RIC) 150 that performs autonomous configuration and optimization of the vRAN 100. The near real-time RIC 150 may be part of a service management and orchestration (SMO) platform.

The division of functionality between the vDU 130 and the vCU 140 may depend on a functional split architecture. The vCU 140 may be divided into a central unit control plane (CU-CP) and central unit user plane (CU-UP). CU-UP may include the packet data convergence protocol (PDCP) layer and the service data adaptation (SDAP) layer, and the radio resource control (RRC) layer. Different components or layers may have different latency and throughput requirements. For example, the PHY layer may have latency requirements between 125 μs and 1 ms and a throughput requirement greater than 1 Gbps, the MAC and RLC layers may have latency requirements between 125 μs and 1 ms and a throughput requirement greater than 100 Mbps, and the higher layers at the vCU may have latency requirements greater than 125 μs and a throughput requirement greater than 100 Mbps.

Programmability in Open RAN components may be facilitated through the near real-time RIC 150. A network operator can install applications (Apps 152, e.g., xApps in Open RAN) on top of the near real-time RIC 150, which may collect detailed telemetry and may leverage the telemetry to optimize network performance or report issues in near real-time (e.g., >10 ms to seconds). The data collection and control of the vRAN components may be facilitated through service models that must be embedded in the vRAN functions by vendors. The service models may explicitly define the type and frequency of data reporting for each App 152, as well as a list of control policies that the RIC can use to modify the RAN behavior. Each App 152 may specify its own service model, requiring the collection of different telemetry data.

The initial xApps proposed for standardization by Open RAN focus on optimizing handovers, self-organizing network (SON) functionality, anomaly detection, and coarse grained radio resource allocation. In these use cases, significant network events occur at a low rate (100 s of ms to seconds). The volume of generated telemetry data is low, and all the data are transported to the RIC. This allows Apps 152 to have a full insight into the domain and tune the vRAN functions through a pre-determined set of control policies. Unfortunately, this approach does not scale to many other use cases of RAN monitoring and control for two main reasons.

Firstly, for many lower layer applications (e.g., PHY and MAC), it is inefficient to transport all the data to the near real-time RIC 150 due to the sheer volume of data. For example, applications like localization, channel estimation, interference detection, and beamforming may require uplink IQ samples from the physical layer. Transporting all IQ samples to the RIC requires more than 5 Gbps per cell for 100 MHz 4×4 MIMO. The standard near real-time RIC design overcomes this problem by specifying in the service model of each App the data required in terms of type and frequency (e.g., in a raw or a pre-processed format). The form of pre-processing (e.g., sub-sampling, averages, or subsets of data) greatly depends on the service model, posing a serious limitation to interoperability because vRAN vendors must implement and support each proprietary service model.

Secondly, many real-time control loops (e.g., packet scheduling and power control), have very tight time constraints (<10 ms). Such time constraints cannot be met by the standard near real-time RIC design that has an expected latency in the order of hundreds of milliseconds. As in the case of telemetry, the App choice of control policy is limited by a set of (standardized) policies that the appropriate service model of the RIC provides. vRAN vendors must implement and integrate such algorithms in their stack, while ensuring that they do not affect the run time performance of the vRAN component. This framework of services models implanted by the vRAN vendor makes it very difficult to practically implement new custom variants of tight control loops.

In an aspect, the present disclosure provides for an analysis node 172 that may be executed on the same resources 170 (e.g., server or server rack) as the virtual radio functions (e.g., vDU 130 and vCU 140). The resources 170 include multiple processor cores, and the analysis node 172 may be isolated from the virtual radio functions and executed on different processor core(s). The virtual radio functions are configured with dynamic service models 176 that define one or more hook points within the instructions for operating a network function and one or more parameters that can be accessed by a codelet at the hook point. The codelets may communicate according to the dynamic service model to export selected operational data and receive control information from the analysis node 172 via an O-RAN interface. In some implementations, the analysis node 172 includes one or more dynamically loaded programs 174 that access the streams of operational data. For example, the dynamically loaded programs 174 may include WebAssembly (Wasm) programs, which allow flexibility for machine-learning models while also providing control over run time. The analysis node 172 may be configured to execute other dynamically loaded programs, which may, for example, be implemented as bytecode (e.g., extended Berkely packet filter (eBPF bytecode), containers, or virtual machines.

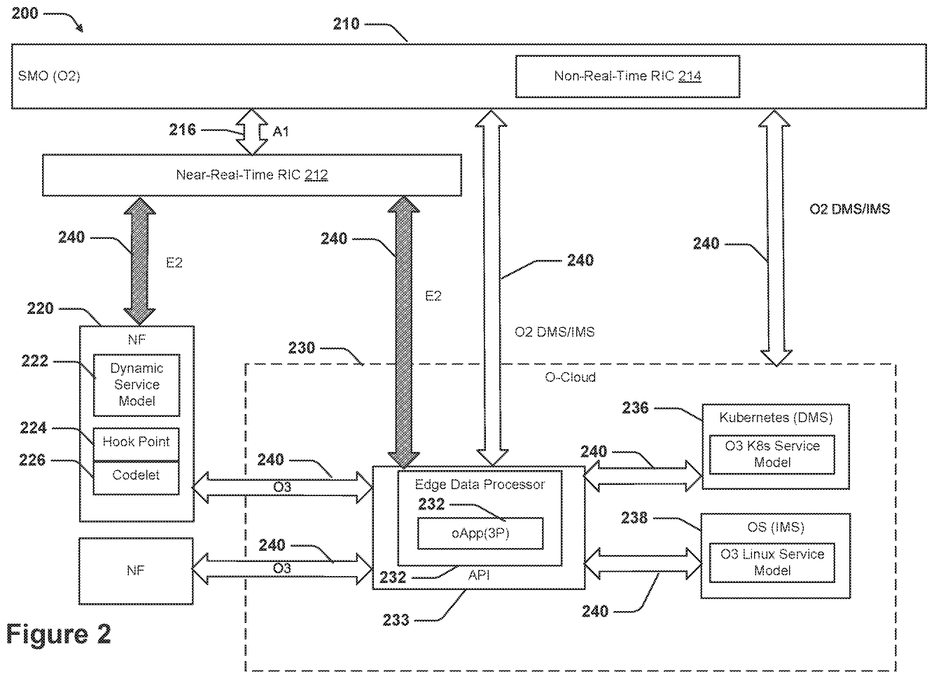

FIG. 2 is a diagram of a first example network architecture 200 for dynamic service models. The network architecture 200 includes a service management and orchestration (SMO) platform 210, near-real-time radio intelligent controller (near-RT RIC) 212 network functions 220, and an O-Cloud 230.

The SMO platform 210 is responsible for RAN domain management such as RAN management, core management, transport management, end-to-end slicing management etc. In some implementations, the SMO platform 210 may include a non-real-time RIC (non-RT RIC) 214. In some implementations, the control plane operations for the dynamic service models 176 may be performed either directly via the near-RT RIC 212 and the E2 interface 240 or via the non-RT RIC 214 from the SMO platform 210. For example, the non-RT RIC 214 may use the near-RT RIC 212 as a proxy (e.g., via the A1 interface 216).

The network functions 220 may correspond to network functions such as the vDU 130 and the vCU 140. Each network function 220 may be configured with a dynamic service model 222. The dynamic service model 222 defines one or more hook points 224 within the instructions for operating the network function. The dynamic service model 222 also defines one or more parameters that can be accessed by a codelet 226 at the hook point 224. The codelet 226 may be bytecode that executes at the hook point 224 within the network function 220. For instance, the codelet 226 may be eBPF bytecode, which may be executed in kernel space or user space.

The O-Cloud 230 a cloud computing platform including a collection of physical infrastructure nodes that meet O-RAN requirements to host the relevant O-RAN functions, the supporting software components, and the appropriate management and orchestration functions. The O-Cloud 230 may include, for example, deployment management service (DMS) 236 (e.g., Kubernetes (K8s)) and an operating system (OS) (e.g. Linux) for an infrastructure management service (IMS) 238. In an aspect, the O-Cloud 230 includes an edge data processor 232. The edge data processor may execute applications 234. The edge data processor 232 may define a fast input-output stream application programming interface (API) 233 for communication with the network functions 220 and the services (e.g., DMS 236 and IMS 238) via an O3 interface 240. In some implementations, the network functions 220 may be collocated (e.g., same edge datacenter) with the edge data processor 232. The O3 interface 240 may utilize one or more of: direct memory access, a kernel bypassing framework, or sockets for fast stream communications. For example, the fast communications may have a latency on the order of microseconds (μs) in order to allow the edge data processor to make decisions for a network function 220 and meet the slot and mini-slot timing of RAN transmissions.

In an implementation, the communications over the O3 interface 240 may be defined by the codelet 226. For example, the codelet 226 may configure the network function 220 to export the one or more parameters to the analysis node (e.g., edge data processor 232) via a telemetry protobuf. The codelet 226 may receive control information for the network function from the analysis node.

In some implementations, the SMO platform 210 and/or near-RT RIC 212 may communicate with the network functions 220 and/or the edge data processor 232 via an E2 interface to facilitate the dynamic service model 222. For example, the network function 220 may receive the dynamic service model 222 from the SMO via the near-RT RIC 212 and the E2 interface 240. The SMO and/or near-RT RIC 212 may load codelets to the network function via the edge data processor 232. For example, the edge data processor 232 may receive a report subscription for a trigger event via the E2 interface. The edge data processor 232 may send an indication message via the E2 interface in response to the trigger event. The edge data processor 232 may receive a control message via the E2 interface to load or unload a codelet to the network function or to forward control information to the codelet.

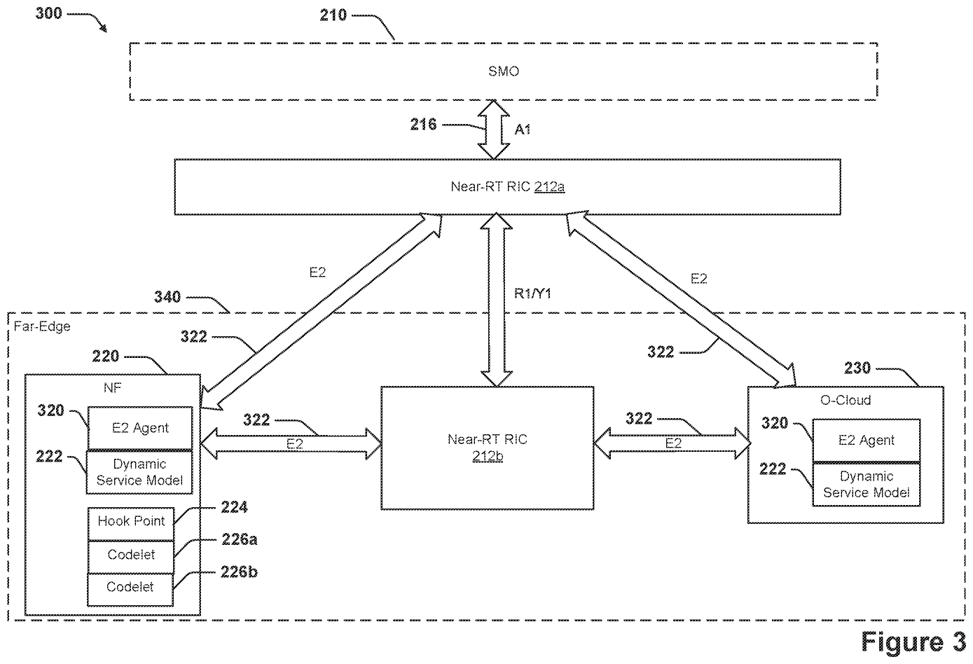

FIG. 3 is a diagram of a second example network architecture 300 for dynamic service models. The network architecture 300 may add dynamic service models without defining a new node. The network architecture 300 includes two near-RT RICs 212a and 212b that function as analysis nodes. For example, the first near-RT RIC 212a may be associated with the SMO platform 210 via an A1 interface 216 and/or located in a near edge datacenter. The second near-RT RIC 212b is located at a far-edge datacenter 340, which may correspond to the resources 170. That is, the second near-RT RIC 212b may be collocated with the network functions 220. The far-edge datacenter 340 may also host the O-Cloud 230.

In an aspect, the network functions 220 and the O-Cloud 230 may be E2 agents 320 of the two near-RT RICs 212a and 212b. Each E2 agent 320 may have a dynamic service model 222 for communicating with the first near-RT RIC 212a and/or the second near-RT RIC 212b via a respective E2 interface 322. For example, the E2 agent 320 may communicate with a remote near-RT RICS 212a via a first E2 interface to receive a first codelet 226a. The E2 agent may communicate with the local near-RT RIC 212b via a second E2 interface to receive a second codelet 226b. A first set of parameters for the first codelet 226a and a second set of parameters for the second codelet 226b are mutually exclusive. That is, the dynamic service model may divide access to parameters between the first near-RT RIC 212a and the second near-RT RIC 212b. Additionally, the first near-RT RIC 212a and the second near-RT RIC 212b may be configured to communicate via an A1 interface or a new interface (e.g., an R1 interface) which may be similar to an extended Y1 interface to coordinate the first set of parameters and the second set of parameters.

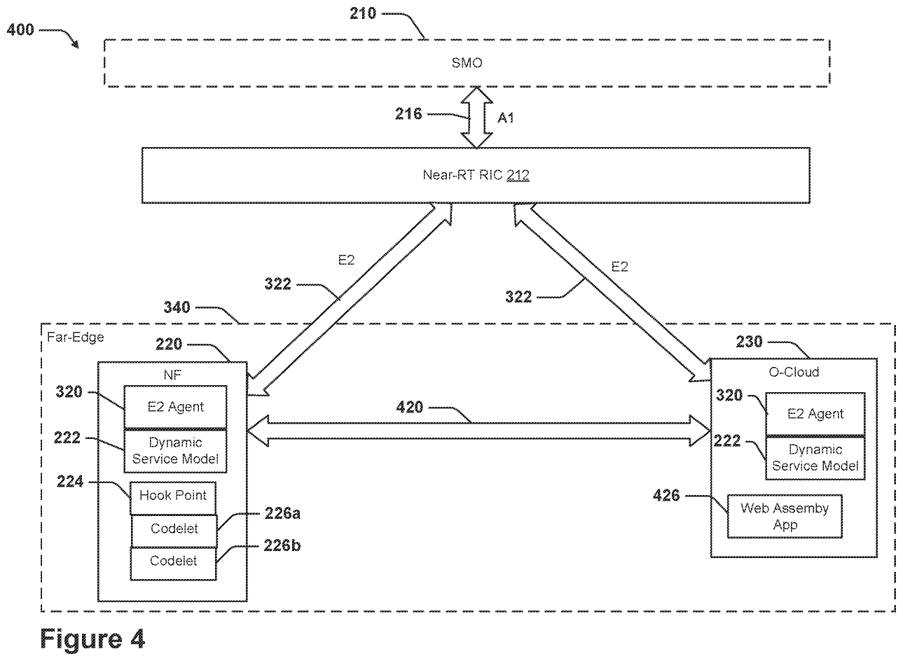

FIG. 4 is a diagram of a third example network architecture 400 for dynamic service models. The network architecture 400 may include network functions 220 and O-Cloud 230 at the far-edge datacenter 340 as E2 agents of a near-RT RIC associated with the SMO platform 210. The network functions 220 and O-Cloud 230 may communicate directly via a new API 420, which may be a fast input-output stream API utilizing one or more of: direct memory access, a kernel bypassing framework, or sockets. For example, a network function 220 may be configured with a dynamic service model 222 that allows communication with a dynamically loaded program 174 at the O-Cloud 230. For example, the dynamically loaded programs 174 may include a WebAssembly (Wasm) app 426 or an eBPF codelet 226.

The network function 220 is configured to communicate with the remote near-RT RIC 212 via a first E2 interface 322 to receive network function 220 is configured to a first codelet 226a. In some implementations, the SMO platform 210 and/or non-RT RIC 214 may use the near-RT RIC 212 as a proxy to provide the first codelet 226a. The network function 220 is configured to communicate with another E2 agent of the near-RT RIC 212 (e.g., O-Cloud 230) via a second fast input-output stream API 420 utilizing one or more of: direct memory access, a kernel bypassing framework, or sockets to receive a second codelet 226b. The E2 agent 320 at the O-Cloud 230 is configured with a dynamic service model for executing web assembly code such as web assembly app 426, which may be dynamically loaded via the E2 interface 322.

FIG. 5 is a flow diagram of an example of a method 500 for using a dynamic service model to provide access to operational data of a radio access network virtual function to an analysis node within an O-RAN framework. For example, the method 500 can be performed by a computing system such as resources 170 hosting a network function 220 and/or one or more components thereof.

At block 510, the method 500 may optionally include communicating with a near-RT RIC via an E2 interface to receive a dynamic service model. In an example, the network function 220 can communicate with the near-RT RIC 212 via an E2 interface 240 to receive a dynamic service model 222. For instance, the network function 220 may be an E2 agent of the near-RT RIC 212.

At block 520, the method 500 includes providing, by a network function, a dynamic service model that defines one or more hook points within instructions for operating the network function and one or more parameters that can be accessed by a codelet at the hook point. In an example, the network function 220 can provide the dynamic service model 222 that defines one or more hook points 224 within instructions for operating the network function and one or more parameters that can be accessed by a codelet 226 at the hook point. For instance, the network function 220 may provide the dynamic service model to the analysis node 172 via an interface such as an E2 interface or an O3 interface.

At block 530, the method 500 includes dynamically receiving a codelet from an analysis node. For example, the network function 220 can receive the codelet 226 from the analysis node 172. In some implementations (e.g., the architecture 200 in FIG. 2), at sub-block 532, the network function 220 may communicate with the edge data processor 232 via an O3 interface 240 with a fast input-output stream API 233 utilizing one or more of: direct memory access, a kernel bypassing framework, or sockets. In some implementations (e.g., the architecture 300 in FIG. 3), at sub-block 534, the network function 220 may communicate with a remote near-RT RIC 212a via a first E2 interface 322 to receive a first codelet 226a. In sub-block 536, the network function 220 may communicate with a local near-RT RIC 212b via a second E2 interface 322 to receive a second codelet 226b. A first set of parameters for the first codelet 226a and a second set of parameters for the second codelet 226b are mutually exclusive. In some implementations (e.g., the architecture 400 in FIG. 4), the network function 220 may execute sub-block 534 to communicate with the SMO platform 210. In sub-block 538, the network function 220 can communicate with another E2 agent (e.g., O-Cloud 230) of the remote SMO platform 210 via a second fast input-output stream API 420 utilizing one or more of: direct memory access, a kernel bypassing framework, or sockets to receive a second codelet 226b. The other E2 agent 320 is configured with a dynamic service model for executing web assembly code (e.g., web assembly app 426).

At block 540, the method 500 includes verifying that the codelet complies with the dynamic service model. In an example, the network function 220 can execute an eBPF verifier to verify that the codelet 226 complies with the dynamic service model 222.

At block 550, the method 500 includes executing the codelet at one of the hook points. In an example, the network function 220 can execute the codelet 226 at one of the hook points 224. For instance, in sub-block 552, executing the codelet may export the one or more parameters to the analysis node 172 via a non-serialized data structure (e.g., a protobuf). In sub-block 554, executing the codelet may receive control information for the network function from the analysis node 172.

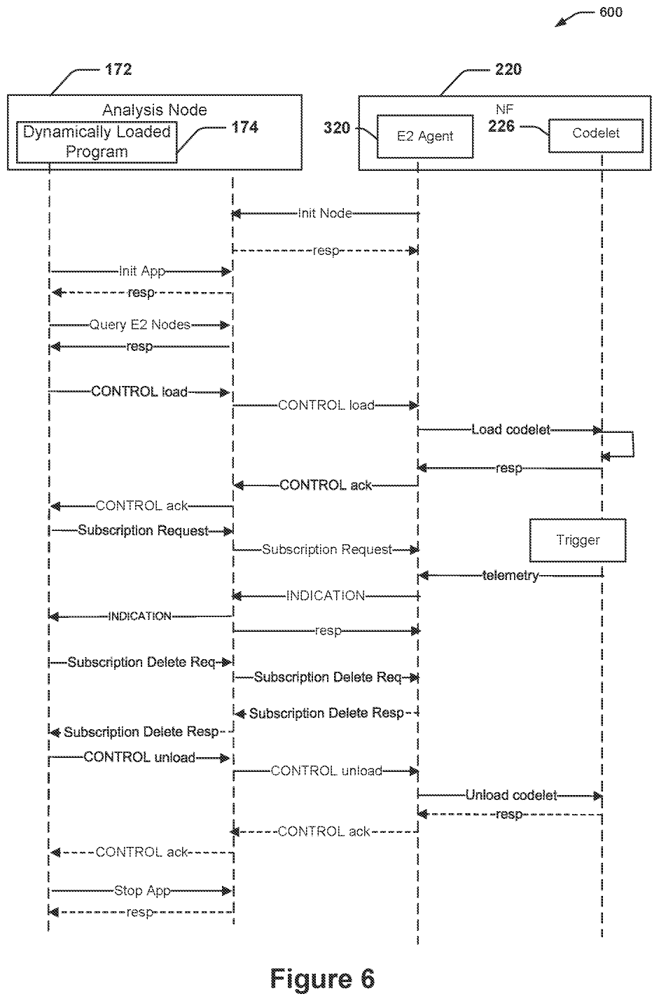

FIG. 6 is a message diagram 600 of example communications for executing a codelet to export operational data. The messages may be exchanged between an analysis node 172 (e.g., a near-RT RIC 212) and a network function 220. The analysis node 172 may have a dynamically loaded program 174 (e.g., an xApp or a Wasm app). In an implementation, the analysis node communicates with the network function 220 via an E2 interface. The network function 220 includes an E2 agent 320 and a dynamically loaded codelet 226.

The E2 agent 320 may initialize the E2 node with the analysis node and optionally receive a response. For example, the initializing may include providing or identifying the dynamic service model 176 of the network function 220. The dynamically loaded program 174 may initialize itself with the analysis node 172 and optionally receive a response from the analysis node 172. The dynamically loaded program 174 may query for E2 nodes and receive a response identifying the network function 220.

To load a codelet, the dynamically loaded program 174 may generate a CONTROL command, which the analysis node 172 may forward to the agent 320. The network function 220 may load the codelet 226 and send a response to the E2 agent 320. The E2 agent 320 may then acknowledge the CONTROL command to the analysis node 172, which forwards the acknowledgment to the dynamically loaded program 174.

The dynamically loaded program 174 may subscribe to the codelet 226 to obtain operational data. The dynamically loaded program 174 may send a subscription request to the analysis node 172, which forwards the subscription request to the E2 agent 320. The codelet 226 may autonomously generate telemetry data based on a trigger such as a detected event or periodic reporting. The E2 agent may generate an INDICATION to the analysis node 172 in response to the telemetry data. The analysis node 172 may provide the INDICATION to the dynamically loaded program 174 and provide a response to the E2 agent 320. The codelet 226 may continue to provide telemetry data as further triggers occur.

The dynamically loaded program 174 may stop the flow of data by requesting the analysis node 172 to delete the subscription. The analysis node 172 may forward the request to the E2 agent 320 and receive a response, which the analysis node 172 may forward to the dynamically loaded program 174. The dynamically loaded program 174 may then generate a CONTROL command to unload the codelet 226. The analysis node 172 may forward the unload CONTROL command to the E2 agent 320, which unloads the codelet 226 from the network function 220. The codelet 226 and/or network function 220 may return a response indicating successful unloading. The E2 agent may then acknowledge the CONTROL command, and forward the acknowledgment to the dynamically loaded program 174. The dynamically loaded program 174 may terminate operation with the analysis node 172.

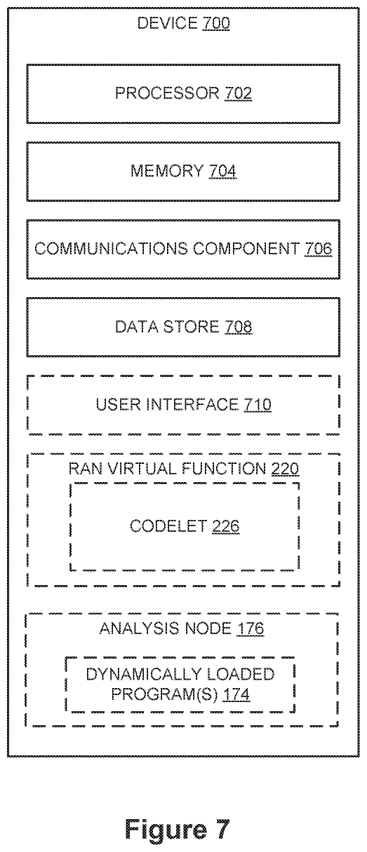

FIG. 7 illustrates an example of a device 700 including additional optional component details. In one aspect, device 700 may include one or more processors 702, which may be processor cores for carrying out processing functions associated with one or more of components and functions described herein. Processor(s) 602 can include a single or multiple set of processors or multi-core processors. Moreover, processor(s) 602 can be implemented as an integrated processing system and/or a distributed processing system.

Device 700 may further include one or more memory/memories 704 for storing local versions of operating systems (or components thereof) and/or applications being executed by processor(s) 702, such as RAN virtual network functions 220 and analysis node 172, etc. Memory/memories 704 can include a type of memory usable by a computer, such as random access memory (RAM), read only memory (ROM), tapes, magnetic discs, optical discs, volatile memory, non-volatile memory, and any combination thereof.

Further, device 700 may include a communications component 706 that provides for establishing and maintaining communications with one or more other devices, parties, entities, etc. utilizing hardware, software, and services as described herein. Communications component 706 may carry communications between components on device 700, as well as between device 700 and external devices, such as devices located across a communications network and/or devices serially or locally connected to device 700. For example, communications component 606 may include one or more buses, and may further include transmit chain components and receive chain components associated with a wireless or wired transmitter and receiver, respectively, operable for interfacing with external devices.

Additionally, device 700 may include a data store 708, which can be any suitable combination of hardware and/or software, that provides for mass storage of information, databases, and programs employed in connection with aspects described herein. For example, data store 708 may be or may include a data repository for operating systems (or components thereof), applications, related parameters, etc. not currently being executed by processor(s) 602. In addition, data store 708 may be a data repository for virtual network functions 220, analysis node 172, and/or one or more other components of the device 700.

Device 700 may optionally include a user interface component 710 operable to receive inputs from a user of device 700 and further operable to generate outputs for presentation to the user. User interface component 710 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, user interface component 710 may include one or more output devices, including but not limited to a display, a speaker, a haptic feedback mechanism, a printer, any other mechanism capable of presenting an output to a user, or any combination thereof.

Device 700 may additionally include the RAN virtual network function 220 configured with the codelet 226 and the analysis node 172 for executing dynamically loaded program(s) 174, as described herein.

The following numbered clauses provide an overview of aspects of the present disclosure:

Clause 1. A computing system comprising: a memory storing computer-executable instructions for operating a network function; and one or more processors configured to execute the instructions for operating the network function, wherein the one or more processors are configured to: provide a dynamic service model that defines one or more hook points within the instructions for operating a network function and one or more parameters that can be accessed by a codelet at the hook point; dynamically receive a codelet from an analysis node; verify that the codelet complies with the dynamic service model; and execute the codelet at one of the hook points.

Clause 2. The computing system of clause 1, wherein to execute the codelet at one of the hook points, the one or more processors are configured to: export the one or more parameters to the analysis node via a telemetry protobuf; and receive control information for the network function from the analysis node.

Clause 3. The computing system of clause 1 or 2, wherein the analysis node is an edge data processor local to the computing system.

Clause 4. The computing system of clause 3, wherein the one or more processors are configured to communicate with the edge data processor via an O3 interface with a fast input-output stream application programming interface (API) utilizing one or more of: direct memory access, a kernel bypassing framework, or sockets.

Clause 5. The computing system of clause 3 or 4, wherein the edge data processor is configured to communicate with a near-real-time radio intelligent controller (RIC) via an E2 interface.

Clause 6. The computing system of clause 5, wherein the edge data processor is configured to: receive a report subscription for a trigger event via the E2 interface; send an indication message via the E2 interface in response to the trigger event; and receive a control message via the E2 interface to load or unload a codelet to the network function or to forward control information to the codelet.

Clause 7. The computing system of any of clauses 1-6, wherein the one or more processors are configured to communicate with a near-real-time RIC via an E2 interface to receive the dynamic service model.

Clause 8. The computing system of any of clauses 1-7, wherein the one or more processors are configured to: communicate with a remote near-real-time RIC via a first E2 interface to receive a first codelet; and communicate with a local RIC via a second E2 interface to receive a second codelet, wherein a first set of parameters for the first codelet and a second set of parameters for the second codelet are mutually exclusive.

Clause 9. The computing system of clause 8, wherein the local RIC is configured to communicate with the remote near-real-time RIC via a Y1 interface to coordinate the first set of parameters and the second set of parameters.

Clause 10. The computing system of any of clauses 1-9, wherein the processor is configured to: communicate with a near-real-time RIC platform via a first E2 interface as an E2 agent to receive a first codelet; and communicate with another E2 agent of the near-real-time RIC via a second fast input-output stream application programming interface (API) utilizing one or more of: direct memory access, a kernel bypassing framework, or sockets to receive a second codelet, wherein the E2 agent is configured with a dynamic service model for executing web assembly code.

Clause 11. A method comprising: providing, by a network function, a dynamic service model that defines one or more hook points within instructions for operating the network function and one or more parameters that can be accessed by a codelet at the hook point; dynamically receiving a codelet from an analysis node; verifying that the codelet complies with the dynamic service model; and executing the codelet at one of the hook points.

Clause 12. The method of clause 11, wherein executing the codelet at one of the hook points comprises: exporting the one or more parameters to the analysis node via a non-serialized data structure; and receiving control information for the network function from the analysis node.

Clause 13. The method of clause 12, further comprising communicating with the analysis node via an O3 interface with a fast input-output stream application programming interface (API) utilizing one or more of: direct memory access, a kernel bypassing framework, or sockets.

Clause 14. The method of any of clauses 11-13, further comprising communicating with a near-real-time radio intelligent controller (RIC) via an E2 interface to receive the dynamic service model.

Clause 15. The method of any of clauses 11-14, wherein dynamically receiving a codelet from the analysis node comprises: communicating with near-real-time RIC via a first E2 interface to receive a first codelet; and communicating with the analysis node via a second E2 interface to receive a second codelet, wherein a first set of parameters for the first codelet and a second set of parameters for the second codelet are mutually exclusive.

Clause 16. The method of any of clauses 11-15, wherein dynamically receiving a codelet from the analysis node comprises: communicating with a remote near-real-time RIC via a first E2 interface to receive a first codelet; and communicating with another E2 agent of the near-real-time RIC via a second fast input-output stream application programming interface (API) utilizing one or more of: direct memory access, a kernel bypassing framework, or sockets to receive a second codelet, wherein the E2 agent is configured with a dynamic service model for executing web assembly code.

Clause 17. A communications network comprising: an analysis node configured to execute an analysis application based on information from a virtual network function; and the virtual network function configured to: provide a dynamic service model that defines one or more hook points within instructions for operating the virtual network function and one or more parameters that can be accessed by a codelet at the hook point; dynamically receive a codelet from the analysis node; verify that the codelet complies with the dynamic service model; and execute the codelet at one of the hook points.

Clause 18. The communications network of clause 17, wherein the analysis node is an edge data processor local to a computing system hosting the virtual network function and configured to communicate with a near-real-time radio intelligent controller (RIC) via an E2 interface.

Clause 19. The communications network of clause 18, wherein the edge data processor is configured to: receive a report subscription for a trigger event via the E2 interface; send an indication message via the E2 interface in response to the trigger event; and receive a control message via the E2 interface to load or unload a codelet to the network function or to forward control information to the codelet.

Clause 20. The communications network of any of clauses 17-19, wherein the analysis node is a local radio intelligent controller (RIC) configured to communicate with a remote RIC via an A1 interface or an extended Y1 interface to coordinate a first set of parameters to be accessed by a first codelet for the remote RIC and a second set of parameters to be accessed by a second codelet for the local RIC.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media. Non-transitory computer readable media specifically exclude transitory signals.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the claim language. Reference to an element in the singular is not intended to mean “one and only one” unless specifically so stated, but rather “one or more.” Unless specifically stated otherwise, the term “some” refers to one or more. Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A computing system comprising:
a memory storing computer-executable instructions for operating a network function; and
one or more processors configured to execute the instructions for operating the network function, wherein the one or more processors are configured to:
provide a dynamic service model that defines one or more hook points within the instructions for operating a network function and one or more parameters that can be accessed by a codelet at the hook point;
dynamically receive a codelet from an analysis node;
verify that the codelet complies with the dynamic service model; and
execute the codelet at one of the hook points.

2. The computing system of claim 1, wherein to execute the codelet at one of the hook points, the one or more processors are configured to:
export the one or more parameters to the analysis node via a telemetry protobuf; and
receive control information for the network function from the analysis node.

3. The computing system of claim 1, wherein the analysis node is an edge data processor local to the computing system.

4. The computing system of claim 3, wherein the one or more processors are configured to communicate with the edge data processor via an O3 interface with a fast input-output stream application programming interface (API) utilizing one or more of: direct memory access, a kernel bypassing framework, or sockets.

5. The computing system of claim 3, wherein the edge data processor is configured to communicate with a near-real-time radio intelligent controller (RIC) via an E2 interface.

6. The computing system of claim 5, wherein the edge data processor is configured to:
receive a report subscription for a trigger event via the E2 interface;
send an indication message via the E2 interface in response to the trigger event; and
receive a control message via the E2 interface to load or unload a codelet to the network function or to forward control information to the codelet.

7. The computing system of claim 1, wherein the one or more processors are configured to communicate with a near-real-time RIC via an E2 interface to receive the dynamic service model.

8. The computing system of claim 1, wherein the one or more processors are configured to:
communicate with a remote near-real-time RIC via a first E2 interface to receive a first codelet; and
communicate with a local RIC via a second E2 interface to receive a second codelet, wherein a first set of parameters for the first codelet and a second set of parameters for the second codelet are mutually exclusive.

9. The computing system of claim 8, wherein the local RIC is configured to communicate with the remote near-real-time RIC via a Y1 interface to coordinate the first set of parameters and the second set of parameters.

10. The computing system of claim 1, wherein the processor is configured to:
communicate with a near-real-time RIC platform via a first E2 interface as an E2 agent to receive a first codelet; and
communicate with another E2 agent of the near-real-time RIC via a second fast input-output stream application programming interface (API) utilizing one or more of: direct memory access, a kernel bypassing framework, or sockets to receive a second codelet, wherein the E2 agent is configured with a dynamic service model for executing web assembly code.

11. A method comprising:
providing, by a network function, a dynamic service model that defines one or more hook points within instructions for operating the network function and one or more parameters that can be accessed by a codelet at the hook point;
dynamically receiving a codelet from an analysis node;
verifying that the codelet complies with the dynamic service model; and
executing the codelet at one of the hook points.

12. The method of claim 11, wherein executing the codelet at one of the hook points comprises:
exporting the one or more parameters to the analysis node via a non-serialized data structure; and
receiving control information for the network function from the analysis node.

13. The method of claim 12, further comprising communicating with the analysis node via an O3 interface with a fast input-output stream application programming interface (API) utilizing one or more of: direct memory access, a kernel bypassing framework, or sockets.

14. The method of claim 11, further comprising communicating with a near-real-time radio intelligent controller (RIC) via an E2 interface to receive the dynamic service model.

15. The method of claim 11, wherein dynamically receiving a codelet from the analysis node comprises:
communicating with near-real-time RIC via a first E2 interface to receive a first codelet; and
communicating with the analysis node via a second E2 interface to receive a second codelet, wherein a first set of parameters for the first codelet and a second set of parameters for the second codelet are mutually exclusive.

16. The method of claim 11, wherein dynamically receiving a codelet from the analysis node comprises:
communicating with a remote near-real-time RIC via a first E2 interface to receive a first codelet; and
communicating with another E2 agent of the near-real-time RIC via a second fast input-output stream application programming interface (API) utilizing one or more of: direct memory access, a kernel bypassing framework, or sockets to receive a second codelet, wherein the E2 agent is configured with a dynamic service model for executing web assembly code.

17. A communications network comprising:
an analysis node configured to execute an analysis application based on information from a virtual network function; and
the virtual network function configured to:
provide a dynamic service model that defines one or more hook points within instructions for operating the virtual network function and one or more parameters that can be accessed by a codelet at the hook point;
dynamically receive a codelet from the analysis node;
verify that the codelet complies with the dynamic service model; and
execute the codelet at one of the hook points.

18. The communications network of claim 17, wherein the analysis node is an edge data processor local to a computing system hosting the virtual network function and configured to communicate with a near-real-time radio intelligent controller (RIC) via an E2 interface.

19. The communications network of claim 18, wherein the edge data processor is configured to:
receive a report subscription for a trigger event via the E2 interface;
send an indication message via the E2 interface in response to the trigger event; and
receive a control message via the E2 interface to load or unload a codelet to the network function or to forward control information to the codelet.

20. The communications network of claim 17, wherein the analysis node is a local radio intelligent controller (RIC) configured to communicate with a remote RIC via an A1 interface or an extended Y1 interface to coordinate a first set of parameters to be accessed by a first codelet for the remote RIC and a second set of parameters to be accessed by a second codelet for the local RIC.
